(19) United States
(12) Patent Application Publication
(10) Pub. No.: US 2014/0213103 A1
(43) Pub. Date: Jul. 31, 2014

(54) ADAPTER DEVICE WITH MECHANICAL INTERFACE

(71) Applicants: GERD OHMEYER, Haslach (DE); Johannes Falk, St. Georgen (DE)

(72) Inventors: GERD OHMEYER, Haslach (DE); Johannes Falk, St. Georgen (DE)

(73) Assignee: VEGA GRIESHABER KG, Wolfach (DE)

(21) Appl. No.: 14/059,811

(22) Filed: Oct. 22, 2013

(30) Foreign Application Priority Data
Jan. 30, 2013 (EP) 13 153 368.9

(51) Int. Cl. H01R 13/73

(52) U.S. Cl. CPC H01R 13/73
USPC 439/571

(57) ABSTRACT

The invention relates to an adapter device with a mechanical interface and with an electrical interface for the electrical connection to an electronic insert of a measuring apparatus housing comprising a sensor unit. According to the invention, the adapter device comprises a supporting element, and the mechanical interface for a mechanical securing of the adapter device is configured at an interface slot of the electronic insert and/or of the measuring apparatus housing, as a resilient and non-electrically conducting casting compound which partially surrounds the supporting element of the adapter device, with at least one contour element which is adapted substantially true to contour to the interface slot and which establishes a securing operative connection to said slot.

### CROSS REFERENCE TO RELATED APPLICATIONS

This application relates to and claims priority from European App. Ser. No. 13 153 368.9 filed Jan. 30, 2013, the entire contents of which are incorporated herein by reference.

### FIGURE SELECTED FOR PUBLICATION

FIG. 6

### BACKGROUND OF THE INVENTION

1. Field of the Invention

The present invention relates to an adaptor device with a mechanical interface. More particularly, the present invention provides an adaptor device and system with a mechanical interface for adapting to a measuring apparatus for improved security and reliability.

2. Description of the Related Art

The series manufacture of measuring apparatuses, in particular of filling level and pressure measuring apparatuses, is facilitated by standardizing as many component parts and components of the measuring apparatuses as possible. This applies particularly to the functions which perform the measuring task itself.

However, occasionally standard measuring apparatuses with additional functions have to be provided, which are implemented with additional component groups. Since an additional installation space is needed for these additional component groups, these additional component groups are often accommodated loosely, that is to say, depending on the space conditions, in hollow cavities in the housing of the measuring apparatus between the electronic component group as main component group and the housing wall, in a position that is not fixed, and they are therefore exposed to the risk of damage caused by the surrounding component parts due to sharp edges or hot surfaces, for example. Furthermore, it is also not possible to prevent, during the installation of such additional component groups, the occurrence of increased installation forces, which can also lead to damage, especially at the electrical interfaces.

Moreover, it is occasionally necessary to increase the housing length in the case of a standardized filling level or pressure measuring apparatus, and therefore also the length of the electrical connection lines between the electronic component group and the sensor unit. For reasons pertaining to costs, another cost operative connection system has to be used here, so that, for the purpose of carrying out an adapter function between the different connection systems, an additional group is also needed. In the case of great lengths, the shielding of the connection lines to the sensor unit or the drive lines to the sensor often also requires another design, which necessitates a change from the standard implementation of the connection and line technologies to another connection technology, and for this purpose as well an additional component group implementing the adapter function between the different line technologies is needed.

From WO 2007/073876 A2, the entire contents of which are incorporated herein by reference, an adapter device configured as an electronic module is known, which, for the formation of an electronic insert arrangement for a measuring apparatus by means of a mechanical interface configured as an attachment device, is connected in a mechanically detachable manner via an attachment device of electronic insert to said insert. Furthermore, both the electronic insert and also the electronic module comprise an electrical interface, and the interfaces have to be connected electrically to each other. The two attachment devices of the electronic insert and of the electronic module can be made to engage to achieve their coupling in such a manner that a distance between the two electrical interfaces remains essentially constant in the case of movement of the electronic insert. The electronic insert is set up for carrying out processes of a first functionality and the electronic module is set up for carrying out processes of a second functionality.

In addition to the high construction costs for producing the two attachment devices, these known attachment devices are unable to eliminate all the above mentioned disadvantages if an additional component group is needed.

### ASPECTS AND SUMMARY OF THE INVENTION

Based on this prior art, the problem of the present invention is to further develop an adapter device of the type mentioned at the start, in such a manner that, on the one hand, a fixed-position securing of the adapter device as an additional component group, which is protected from damage, in the measuring apparatus housing is made possible using cost effective means which are easy to produce, and, on the other hand, to make available a broad range of potential applications, without entailing a complex installation activity.

Such an adapter device with a mechanical interface and with an electrical interface for the electrical connection to an electronic insert of a measuring apparatus housing comprising a sensor unit is characterized according to the invention in that

the adapter device comprises a supporting element, and

the mechanical interface for a mechanical securing of the adapter device is configured at an interface slot of the electronic insert and/or of the measuring apparatus housing, as a resilient and non-electrically conducting casting compound which partially surrounds the supporting element of the adapter device, with at least one contour element which is adapted substantially true to contour to the interface slot and which establishes a securing operative connection to said slot.

The production of the contour element together with the casting compound by overmolding the supporting element of the adapter device makes it possible to obtain contours or geometries of any desired shape, so that the adapter device can be adapted in any position within the measuring apparatus housing to the geometry of the electronic insert and/or of the measuring apparatus housing, which is used as interface slot, and can thus be secured in a fixed position inside the apparatus housing. The securing operative connection of the contour element can be implemented in multiple ways, such as, for example, by clamping, bracing or gripping to the contour of the interface slot of the electronic insert and/or of the measuring apparatus housing or by engagement by means of engagement elements with the interface slot of the electronic insert and/or the apparatus housing. For securing this adapter device within the measuring apparatus housing no additional work steps, such a gluing, welding or riveting, or other component parts, for example, connection means, are therefore required.

Such adapter devices according to the invention can to be produced cost effectively by means of appropriate casting tools.

Using these adapter devices according to the invention, standard measuring apparatuses can be expanded or adapted cost effectively in terms of their functions or of their design. Furthermore, using the securing according to the invention by means of a contour element of the casting compound, installation forces acting on the adapter device can be eliminated or at least reduced. Finally, protection from vibration and thus also protection from abrasion as well as protection from hot surfaces during operation and from humidity can be achieved, especially during the installation and removal of the adapter device.

In a particularly advantageous embodiment of the invention, the contour element is configured with a slit for the margin-side and resiliently clamping reception of a plate-shaped support of the electronic insert, which forms the interface slot. Thus, in a simple installation step, the adapter device can be attached by clamping to the plate-shaped support, for example, a printed circuit board of the electronic insert, in order to secure or to stop the adapter device in this manner in a fixed position with respect to the electronic insert.

According to an additional advantageous variant of the invention, it is provided that the contour element for the central securing in the measuring apparatus housing is configured with contour which is applied at least partially against the inner wall of the measuring apparatus housing, which forms the interface slot, and which is resiliently braced. In this manner, such an adapter device can be clamped, so that the contour element and therefore the adapter device can be braced resiliently against the inner wall. According to a variant, the contour element here can be formed in the shape of a plate with a contour which is substantially adapted to the cross-sectional shape of the measuring apparatus housing; the contour element is preferably configured in the shape of a star with a radial contour, which is substantially adapted to the cross-sectional shape of the of the measuring apparatus housing.

In a further embodiment of the invention, the contour element is configured with securing means, preferably with pins, ledges and/or engagement hooks, which engage with corresponding securing slot means of the interface slot.

Moreover, according to a variant, the supporting element is configured as a supporting plate, preferably as a printed circuit board.

It is particularly advantageous to configure the supporting plate as a flexible printed circuit board with at least one conductor path. In this manner, the design of the adapter device according to the invention is substantially simplified. Thus, this flexible printed circuit board is used simultaneously for implementing an adapter function between two different connection or line technologies. It is also possible to arrange electronic component elements on this flexible conductor path.

According to a variant of the invention, the adapter device is configured for the electrical connection to the sensor unit with an additional electrical interface.

The adapter device according to the invention is particularly suitable for housings of measuring apparatuses, preferably for filling level measuring apparatuses or pressure measuring apparatuses.

The above and other aspects, features and advantages of the present invention will become apparent from the following description read in conjunction with the accompanying drawings, in which like reference numerals designate the same elements.

### BRIEF DESCRIPTION OF THE DRAWINGS

FIG. 1 shows a diagrammatic representation of a filling level measuring device with an adapter device according to the invention,

FIG. 2 shows a perspective and diagrammatic representation of the detail A according to FIG. 1 with an embodiment example of the adapter arrangement according to the invention,

FIG. 3 shows a perspective and diagrammatic representation of the adapter device according to FIG. 2,

FIG. 4 shows a perspective and diagrammatic cross-sectional representation of an electronic housing receiving an electronic insert of the measuring device according to FIG. 1, with an additional embodiment example of the adapter device according to the invention,

FIG. 5 shows a perspective and diagrammatic representation of the adapter device according to FIG. 4,

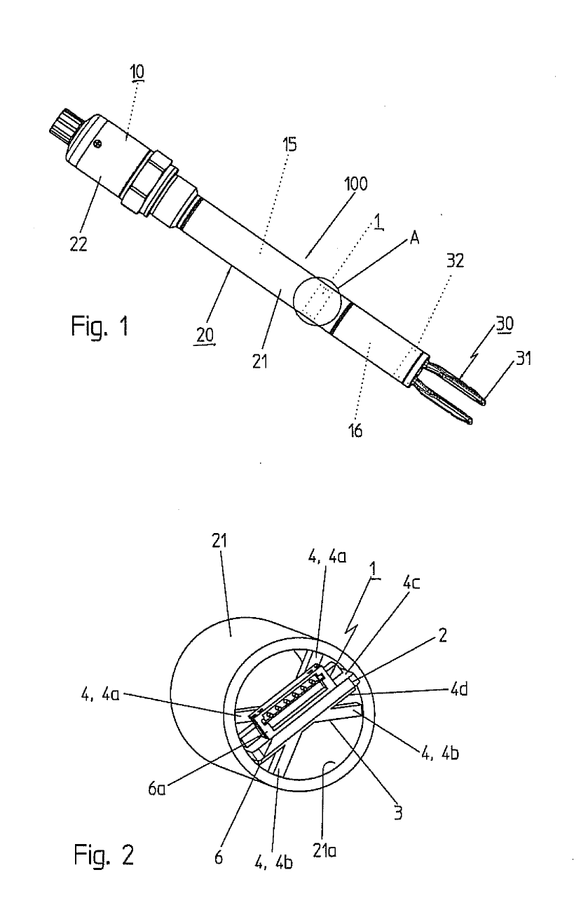

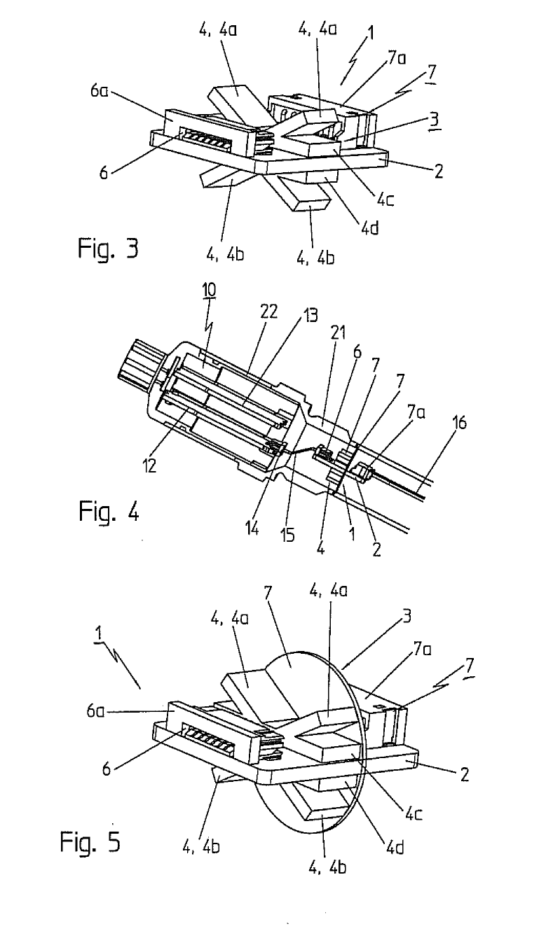

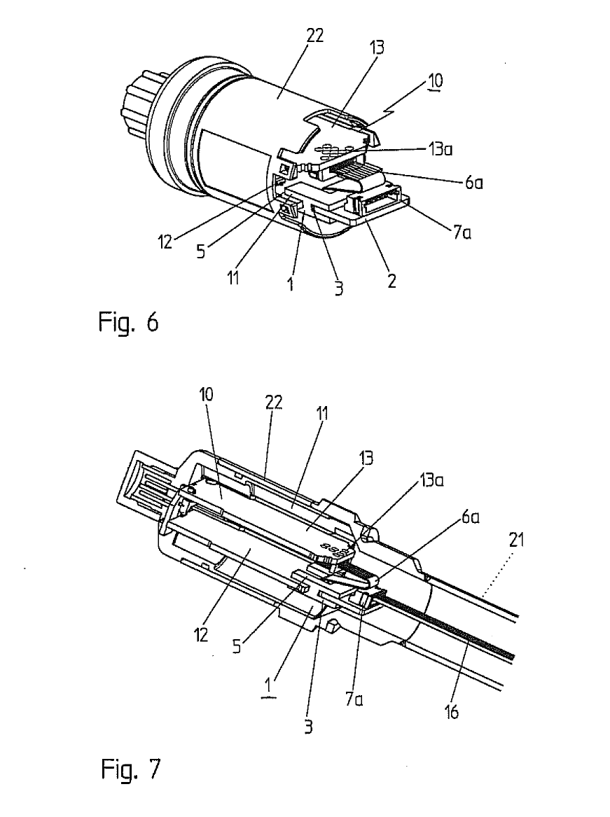

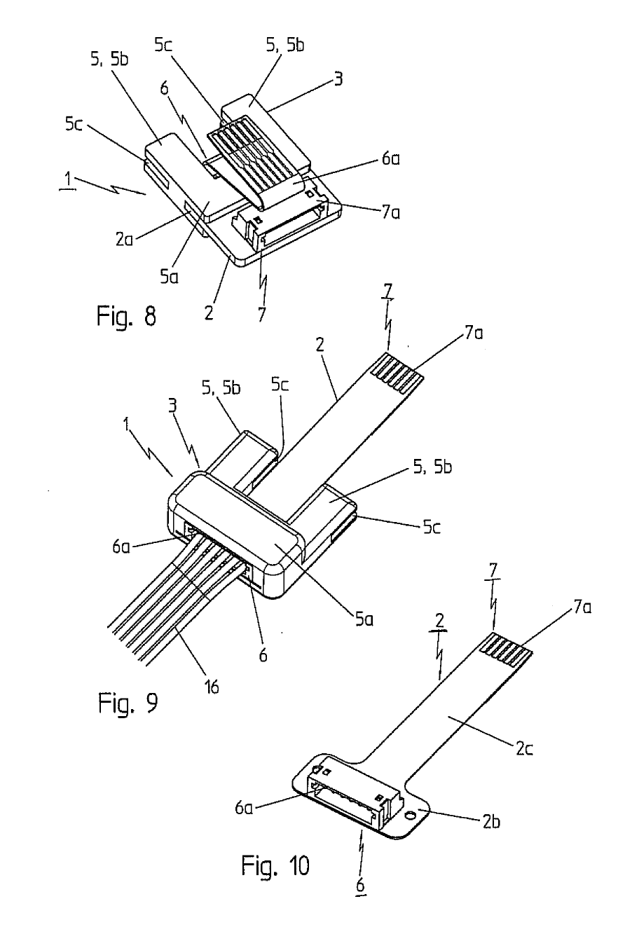

FIG. 6 shows a perspective and diagrammatic representation of an electronic housing receiving an electronic insert according to FIG. 4, with an additional embodiment example of the adapter device according to the invention,

FIG. 7 shows a perspective and diagrammatic longitudinal-sectional representation of the electronic housing according to FIG. 6,

FIG. 8 shows a perspective and diagrammatic representation of the adapter device according to FIG. 7,

FIG. 9 shows a perspective and diagrammatic representation of an additional embodiment example of the adapter device according to the invention with a ready-made line connected to the electrical interface, and

FIG. 10 shows a representation of the flexible printed circuit board, which is used as supporting element of the adapter device according to FIG. 9, with an electrical interface.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

FIG. 1 shows a filling level measuring apparatus 100, which is configured for the detection of liquids as a so-called vibration resonator with a piezoelectric drive system, which, as a rule, comprises a piezoelement for the mechanical vibration excitation, for example, by means of a fork vibrator membrane.

The filling level measuring apparatus 100 according to FIG. 1 comprises a vibration device as sensor unit 30 with a fork vibrator 31 and a drive device 32 accommodated in a measuring tube 21 of a measuring apparatus housing 20. The measuring apparatus housing 20 comprises, in addition to the measuring tube 21, an electronic housing 22 for receiving an electronic sensor 10 which, on the one hand, actuates the drive device 32, and to which, on the other hand, sensor signals generated by the vibration device 30 are supplied for evaluation. For this purpose, the electronic insert 10 is connected by means of an electrical connection line 15 via an adapter device 1 to the vibration device 30, wherein this adapter device 1 is connected via a connection line 16 to the drive device 32.

The filling level measuring apparatus 100 according to FIG. 1 represents a special design, which is derived from a standard design. The difference compared to this standard design is that either no measuring tube 21 is provided, or such a measuring tube 21 has a substantially shorter design. In order to be able to construct such a special design cost effectively, without having to modify the existing component groups of the standard design at high cost, the adapter device 1 according to the invention is used for implementing the appropriate adaptation.

According to FIG. 1, such an adapter device 1 establishes the electrical connection between the electronic insert 10 received by the electronic housing 22, and the sensor unit 30, wherein this adapter device 1 is arranged in the area A of the measuring tube 21, which is adjacent to the sensor unit 30, and which is electrically connected via a connection line 15 to the electronic insert 10. This area A is represented in detail in FIG. 2 with a tube section of the measuring tube 21 and of the adapter device 1. FIG. 3 shows this adapter device 1 in another perspective.

The adapter device 1 comprises a printed circuit board as supporting element 2 with an electrical interface 6 and an additional electrical interface 7, which are each configured as clamp connector 6a or 7a. These two clamp connectors 6a and 7a are connected electrically to each other via conductor paths (not shown in the figures) led over the printed circuit board 2.

For the establishment of a mechanical interface 3, the printed circuit board 2 is partially overmolded, so that, according to FIG. 2, a resilient and non-electrically conducting casting compound 3 with a contour element 4 is formed, by means of which the adapter device 1 is clamped to the inner wall 21a as interface slot of the measuring tube 21 or of the measuring apparatus housing 20, and as a result it is braced by means of this contour element 4 against the inner wall 21a. The adapter device 1 is thus secured in the measuring tube 21 in a fixed position and centered, and it is protected from contact with the surrounding measuring tube 21. In addition, a reduction in tensile stress and pressure on the adapter device 1 is achieved.

This central securing of the adapter device 1 is implemented by means of a star-shaped contour element 4 of the casting compound 3 (or the casting), wherein the star shape is formed by four contour arms 4a and 4b. Other contours are also conceivable here. In the state incorporated in the measuring tube 21, the four contour arms 4a and 4b extend, relative to the measuring tube 21 in a radial direction, so that the front faces at the ends of these contour arms 4a and 4b are applied resiliently against the inner wall 21a. The width of the printed circuit board 2 and the length of two ledge-shaped cast bodies 4c and 4d correspond to the inner diameter of the measuring tube 21. These two star-shaped cast bodies 4c and 4d are led in the center between the two clamp connectors 6a and 7a on opposite surfaces of the printed circuit board 2, and they each support two contour arms 4a and 4b. For the formation of the star shape, the two contour arms 4a and 4b each extend in the center from the cast body 4c or 4b radially outward.

An additional embodiment example is shown in FIG. 4, which represents the electronic housing 22, which is connected to the other end of the measuring tube 21, for receiving the electronic insert 10. In this end area of the measuring tube 21, in a manner corresponding to FIG. 2, an adapter device 1 is also clamped in, which, however, differs from the embodiment represented in FIG. 3 in that the casting compound 3 with the star-shaped contour arms as contour element 4 comprises in addition a sealing plate 7, as represented in FIG. 5.

This sealing plate 7 corresponds to the cross-sectional shape of the cross section of the measuring tube 21, which is formed by the inner wall 21a, and it is manufactured as a single piece by overmolding the printed circuit board 2 together with the casting compound 3.

By means of such a sealing plate 7, the penetration of moisture into the area of the electronic insert 10 is prevented. The star-shaped design of the contour element 4 can also be replaced completely by such a sealing plate 7. Furthermore, it is also possible to overmold the printed circuit board 2 completely, so that only the front side of the printed circuit board 2, which is applied against the inner wall 21a, remains uncovered. As a result, the printed circuit board 2 is also protected from moisture, particularly if electrical or electronic component elements are arranged on this printed circuit board 2.

According to FIG. 4, the electronic unit 10 comprises two printed circuit boards 12 and 13 fitted with electrical and/or electronic component elements, wherein the printed circuit board 12 comprises an electrical interface 14, by means of which the electrical connection to the electrical interface 6 of the adapter device 1 is established by a connection line 15. Via the additional electrical interface 7 of the adapter device 1, the adapter device 1 is electrically connected to the sensor unit 30 of the measuring device 100 by an additional line 16, as described above.

FIGS. 6, 7 and 8 show an additional embodiment example of an adapter device 1 with a mechanical interface also configured as casting compound 3, wherein, however, the associated interface slot is formed not by the inner wall 21 of the measuring tube 21, but by a printed circuit board 12 of the electronic insert 10, in particular by its front-side area 11.

The adapter device 1 according to FIG. 8 also comprises a printed circuit board 2 with an electrical interface 6 and an additional electrical interface 7. The electrical interface 6 is formed by a flexible printed circuit board 6a, while the additional interface 7 is configured as a clamp connector 7a.

The mechanical interface is also implemented by a casting compound 3 with contour elements 5 by overmolding the interface-side marginal area 2a of the printed circuit board 2. In the plane of the printed circuit board 2, the casting compound 3 has a U shape, consisting of a transverse part 5a, which connects two leg portions 5b. The transverse part 5a encloses the marginal area 2a of the printed circuit board 2 like a pocket, while the two leg portions 5b as contour element 5 both comprise a slit 5c whose width corresponds approximately to the thickness of the printed circuit board 12 of the electronic unit 10, and therefore they can be attached by clamping to the margin of the printed circuit board 12, which forms the interface slot 11, so that this marginal area 11 is enclosed by the two leg portions 5b, and the adapter device 1 is secured in a fixed position with respect to the electronic unit 10.

The electrical interface 6 of the adapter device 1 is connected via the flexible printed circuit board 6a to an electrical interface 13a of the additional printed circuit board 13 of the electronic unit 10.

FIGS. 9 and 10 show an alternative embodiment of the adapter device according to FIG. 8, in which the stiff printed circuit board 2 according to FIG. 8 is replaced by a flexible printed circuit board; however, an end area of this flexible printed circuit board 2 also comprises a U-shaped casting compound 3 as mechanical interface.

This flexible printed circuit board 2 is configured according to FIG. 10 so that it has a T shape, wherein, on the transverse part 2b of this T shape is fitted with a clamp connector 6a for the formation of an electrical interface 6. The free end of the longitudinal part 2c of this T shape forms an additional electrical interface 7 with corresponding connection contacts 7a.

The U-shaped casting compound 3 comprises, in accordance with the casting compound according to FIG. 8, as contour element, two leg portions 5b each with a slit 5c, which are connected by a transverse element 5a, wherein this transverse element 5a completely encloses as an overmold the transverse part 2b of the flexible printed circuit board 2 up to the access to the clamp contacts of the clamp connector 6a, so that the longitudinal part 2c of the flexible printed circuit board 2 extends between the two leg portions 5b.

In this manner, this adapter device 1 according to FIG. 9 can be attached instead of the adapter device 1 according to FIG. 8 in the marginal area of the printed circuit board 12, figure which represents the interface slot 11 for the mechanical interface configured as a casting compound 3 with contour elements 5, as represented in connection with the adapter device 1 according to FIG. 8 in FIGS. 6 and 7. According to FIG. 10, the clamp connector 6a of the electrical interface 6 is connected by means of a ready-made line 16 to the sensor unit 30, while the additional electrical interface 7 with the contacts 7a of the flexible printed circuit board 2 is connected to the electrical interface 13a of the printed circuit board 13 of the electronic unit 10.

In order to improve the securing with fixed position within the measuring apparatus housing 20 of the measuring apparatus 100, which can also be configured as a pressure measuring apparatus, the casting compound 3 or the contour elements 4 or 5 can also be configured with pins, ledges and/or engagement hooks which grip, engage and/or clamp to a corresponding counter piece of the interface slot 11 or 21a. The casting compound 3 as a mechanical interface can be implemented cost effectively by overmolding by hot-melting molding of the supporting element 2 of the adapter device 1 by using an appropriate thermoplastic casting material.

The supporting element of the adapter device 1 according to the invention can be used with or without electrical and/or electronic components.

### REFERENCE NUMERALS

1 Adapter device

2 Supporting element, printed circuit board, flexible printed circuit board of the adapter device 1

2a Marginal area of the printed circuit board 2

2b Transverse part of the T-shaped flexible printed circuit board 2

2c Longitudinal part of the T-shaped flexible printed circuit board 2

3 Mechanical interface, casting compound

4 Contour elements

4a Contour arm of the contour element 4

4b Contour arm of the contour element 4

4c Cast body of the casting compound

4d Cast body of the casting compound

5 Contour element

5a Transverse part of the contour element 5

5b Leg portion of the contour element 5

6 Electrical interface of the adapter device 1

6a Clamp connector of the interface 6

7 Additional electrical interface of the adapter device 1

7a Clamp connector of the interface 7

7b Flexible printed circuit board of the interface 7

8 Sealing plate

10 Electronic insert

11 Interface slot of the electronic insert 10

12 Printed circuit board of the electronic insert 10

13 Printed circuit board of the electronic insert 10

13a Electrical interface of the printed circuit board 13

14 Electrical interface

15 Connection line

16 Connection line

20 Measuring apparatus housing

21 Measuring tube of the measuring apparatus housing 20

21a Interface slot, inner wall of the measuring apparatus housing 20

22 Electronic housing of the measuring apparatus housing 20

30 Sensor unit

31 Fork vibrator of the sensor unit 30

32 Drive device of the sensor unit 30

100 Filling level measuring device

Various operations may be described as multiple discrete operations in turn, in a mariner that may be helpful in understanding embodiments of the present invention; however, the order of description should not be construed to imply that these operations are order dependent.

It will also be understood, that as used herein the phrases ‘connection’ or connectable or otherwise, will be an operative phrase for the ability to connect either directly or through other pathways, and is not so limited to the embodiments discussed herein.

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

What is claimed is:

1. An adapter device, enabling an electrical connection to an electronic insert of a measuring apparatus housing having a sensor unit, said adaptor device comprising:
a mechanical interface and an electrical interface operably enabling an reliable electrical connection from said sensor unit of said electronic insert of said measuring apparatus housing to an receiver;
a supporting element, and
said mechanical interface operably formed for mechanically securing said adapter device to an interface slot of said electronic insert of said measuring apparatus housing;
said mechanical interface including means for resiliently and non-electrically securing said adaptor device and which partially surrounds said supporting element of said adapter device, with at least one contour element;
said at least one contour element being adapted substantially true to an interior contour to the interface slot thereby establishing a securing operative connection to said slot.

2. The adapter device, according to claim 1, wherein:
the contour element is configured with a slit for a margin-side and resiliently clamping reception of a plate-shaped support of said electronic insert, which forms the interface slot.

3. The adaptor device, according to claim 1, wherein:
said contour element is operative for a central securing in the measuring apparatus housing and is configured with a contour feature applied at least partially against said inner wall of the measuring apparatus housing, which forms the interface slot, and which is resiliently braced.

4. The adaptor device, according to claim 3, wherein:
said contour element is configured in the shape of a plate with a contour which is substantially adapted to a cross-sectional shape of the measuring apparatus housing.

5. The adaptor device, according to claim 3, wherein:
said contour element is configured in the shape of a star with a radial contour which is substantially adapted to the cross-sectional shape of the measuring apparatus housing.

6. The adaptor device, according to claim 3, wherein:
said contour element is configured with securing means, which operably engage with the corresponding securing slot means of said interface slot; and
said securing means include at least one selected from a group consisting of: pins, ledges, and engagement hooks.

7. The adaptor device, according to claim 3, wherein:
said supporting element is configured as a supporting plate, preferably as a printed circuit board.

8. The adapter device, according to claim 7, wherein:
said supporting plate is configured as a flexible printed circuit board with at least one conductor path.

9. The adaptor device, according to claim 3, wherein:
said adapter device is operably configured for said electrical connection to said sensor unit and an additional electrical interface.

10. A measuring apparatus housing, containing an adaptor device according to claim 1.

11. The measuring apparatus housing, according to claim 10, wherein:
said adaptor device is operative as one of a filling level measuring apparatus and a pressure measuring apparatus.
